(19) United States
(12) Patent Application Publication
(10) Pub. No.: US 2006/0010137 A1
(43) Pub. Date: Jan. 12, 2006

(54) Intelligent interface for managing data content and presentation

(76) Inventor: Terry Johnson, Umina Beach (AU)

Correspondence Address: STITES & HARBISON PLLC, 1199 NORTH FAIRFAX STREET, SUITE 900, ALEXANDRIA, VA, 22314, US

(21) Appl. No.: 10/520,018

(22) PCT Filed: Jul. 1, 2003
(86) PCT No.: PCT/AU03/00847

§ 371 Date: Jul. 20, 2005

(30) Foreign Application Priority Data
Jul. 1, 2002 (AU) PS 3314

(51) Int. Cl. G06F 17/00

(52) U.S. Cl. 707/100

(57) ABSTRACT

An intelligent electronic interface with receives a data stream from a predetermined source of data. The interface may collect, compile, manipulate, adjust or otherwise process the data. For example, it may add content to, enhance the appearance of or reformat the data. The data is then transferred via an output to a predetermined peripheral device such as a printer. Perferably, the electronic interface interrupts passage of said data stream from the predetermined source of data to the predetermined peripheral device. The source of the data stream may be intentionally destined for the peripheral. The data may be a receipt text at a point of sale (POS) device, or may be from some other device whose output is to be printed, but which requires further processing to be made printable, such as a weigh-scale. The invention is described with reference to its application at POS terminals, and more particularly in enhancing the content of a printer such as a receipt printer.

### BACKGROUND

This invention relates to an intelligent electronic interface which receives a data stream from a predetermined source of data, wherein the interface may collect, compile, manipulate, adjust or otherwise process the data such as but not limited to adding content to the data, enhancing the appearance of or reformatting the data, whereupon the data is transferred via an output to a predetermined peripheral device such as but not limited to a printer. Preferably, the electronic interface interrupts passage of said data stream from the predetermined source of data to the predetermined peripheral device.

The source of this data stream may be intentionally destined for a peripheral such as a printer. The data may be receipt text at a point of sale ( POS), or may be a device whose output is to be printed, but which requires further processing to be made printable, such as the output of a weigh-scale. The present invention will be described with reference to its application at POS terminals and more particularly in enhancing the content of a printer such as a receipt printer but it will be appreciated by persons skilled in the art that the invention can be applied to manipulation of data in other data transfer systems or in conjunction with other peripheral devices.

### BACKGROUND ART

There are in existence a wide variety of POS terminal systems which may generally comprise a computer linked to an input and an output such as a receipt printer. Sales transactions are processed on the computer and the receipt data for the consumer is printed at a receipt printer. Systems are known in which buyers transaction data generated at the POS is stored in a memory for future reference. A signal is generated which is representative of a customers shopping history. This allows incentive coupons to be issued to customers in dependence upon the signal.

A common application of small, low cost printers is for the production of receipts or dockets in locations such as supermarkets, petrol stations and general retail outlets.

Currently there exists a good graphic capability in most printers that is often completely ignored. These receipt printers are generally suitable to produce company logos, discount coupons, promotional material, gaming tickets such as lottery entries, and many other marketing tools; either as plain text, graphic image or mixed output.

However, these capabilities are not commonly exploited due to the point-of-sale (POS) equipment being of limited capability. Due to high costs, such as in equipment, training and software development, there are major barriers to the upgrading of a legacy POS system to include such capabilities. This is particularly significant where a company operates a multitude of different systems at different locations. Often the only option is complete replacement of the POS, although even current systems still offer little flexibility.

It is also a problem that the data stream may be incompatible with a connected printer. This could happen where a printer has been replaced with a newer model that has features the legacy software is unable to manage correctly. This is becoming a common occurrence as old dot-matrix printers are being replaced with thermal technologies.

Furthermore, statistical information about what and when data has been printed may also be of value to a business for future marketing and target promotions. This data may reveal customer demographics that simple sales totals fail to show. For example, a food outlet may get some indication of what customers are consuming for meals versus snacks and target marketing accordingly; e.g. food consumed for lunch is mostly purchased at lunch time.

### DISCLOSURE OF INVENTION

It is one object of the present invention to address the foregoing problems or at least to provide the public with a useful choice. By concentrating intelligence in communication with a point of sale system between an input and an output (such as, but not limited to a printer), and interrupting a data stream and providing networking interfaces where appropriate, it is possible to manage a wide disparity of legacy systems across many sites. The present invention enables the provision of through such a network of a range of marketing and presentation information tools, and deliver these capabilities at an affordable price to persons such as service providers.

Where multiple output devices such as printers are located at a single site ( such as a point of sale), a site controller may be used to act as a single point of contact for the group. Data is communicated between a central server to the site controller, which then disseminates the data via a wireless or wired network, or both, to the intelligent interfaces, and collects any statistical or other data for the server.

A further application lies in intelligent data acquisition. It may be that a print out from a data stream not intended to be directly printed is desired. An example of this is a weigh scale where a stream of weight data is output. To print a docket with this data currently requires an intervening computer system to capture the weight, format the data, and output to the printer. This could all be done through an intelligent printer device.

The invention according to one embodiment, typically takes an input data stream (from a data source), manipulates this data, and outputs a stream (to a data consumer). This output stream may be substantially altered and include data completely foreign to the input stream, but significantly may be affected by the specific content of the input stream. The output data may contain content that is pre-loaded into the interface, or obtained via some network connection in real-time from some external device, or some combination of both.

In one broad form the present invention comprises;

a system for collecting and/or adjusting data in a data stream: the system comprising;

a source of electronic data,

an input provided by the source of data and capable of transmission of said data to a first data processing station;

an output in communication with said data processing station;

an interface intermediate said input from said source of electronic data and said central processing station; wherein, the interface is capable of interrupting data from said input

before it reaches the processing station and adjusting and/or compiling said data for uses other than in said processing station.

According to one embodiment, the source of electronic data providing said input may be selected from one or more of the following devices:

a) a scanner

b) keyboard

c) a magnetic card.

According to a preferred embodiment, the interface enables data transmitted between said input and the processing station to be intercepted for secondary adjustment, compilation, manipulation, variation or the like.

Preferably, the processing station is a point of sale sales terminal. According to a preferred embodiment, said output from said processing station communicates with a POS printer. According to one embodiment, the interface allows transmission of adjusted, compiled and/or manipulated data to a secondary data processing station. The secondary data processing station may be either at the point of sale or at a remote location. The secondary data processing station is preferably a site controller capable of communication with at least one data streams According to one embodiment, the secondary processing station is capable of uploading of statistical data and down loading configuration data. The secondary data processing station may perform tasks such as validation of a customer coupon or voucher.

In one broad form the present invention comprises;

a system for interrupting data in a data stream: the system comprising;

a source of electronic data,

an input provided by the source of data and capable of transmission of said data to a first data processing station;

an output in communication with and from said data processing station;

an interface intermediate said input from said source of electronic data and said central processing station; wherein, the interface is capable of interrupting data from said input before it reaches the processing station; whereupon said data is processed at a secondary processing station wherein the data is used for adjusting and/or compiling said data for uses other than in said first processing station.

In another, broad form the present invention comprises;

a system for adjusting data in a data stream: the system comprising;

a source of electronic data,

a printer capable of performing at least one function responsive to said data stream;

an interface for interrupting and adjusting the data stream to enable the printer to thereby perform at least one additional print function.

In another broad form the present invention comprises;

an electronic interface for insertion between a source of electronic data and a printer which performs at least one print function responsive to said data: wherein the interface includes means to interrupt and adjust said data stream so that the printer performs at least one other function responsive to said adjusted data.

In another broad form the present invention comprises:

a system for controlling the printing of data at a point of sale ( POS) terminal, the system comprising:

a source of data producing a data stream;

a printer responsive to a POS computer and which performs at least one print function responsive to the data stream; the system further comprising at least an interface which is capable of adjusting said data in said data stream thereby allowing the printer to perform at least one other print function.

According to one embodiment, the interface is in communication with a remote server and the remote server is in communication with a controller which links one or more remote sites to the remote server.

The system further comprising at least an interface which is capable of adjusting said data in said data stream thereby allowing the printer to perform at least one other print function. Preferably the additional print function is based on POS information obtained by said interface directly or indirectly from the POS computer.

Preferably, the computer terminal is a cash register which delivers a data stream to a receipt printer. The data is manipulated, altered, augmented, amplified or otherwise adjusted via an interface which is either local to or remote from the printer. According to one embodiment the interface connection is wireless. According to an alternative embodiment, the interface connection is wired. In the case where multiple printers are used in a multiple POS site, a controller is used either at the POS site or at a remote location thereby enabling control of multiple printers.

In another broad form of a method aspect, the present invention comprises:

a method for obtaining data from a data stream to enable collection and/or amendment of said data prior to delivery of said data to a final location;

the method comprising the steps of:

a) taking a system comprising;

a source of electronic data,

an input provided by the source of data and capable of transmission of said data to a first data processing station; and

an output in communication with said data processing station;

b) placing an interface intermediate said input from said source of electronic data and said central processing station;

c) enabling the interface to interrupt data from said input before it reaches the first processing station; and

d) adjusting and/or compiling said data;

e) presenting said adjusted and/or compiled data at at least one system peripheral device.

According to one embodiment, the at least one system peripheral device is a remote printer. According to one embodiment the interface is provided by hardware such as a modem connected between the data input and the first processing station. According to an alternative embodiment, the interface is provided by software associated with the first processing station. The software communicates with the data stream and intercepts and/or compiles and/or adjusts the data for storage or for subsequent delivery to an output such as a point of sale (POS) printer.

In another broad form of a method aspect the present invention comprises:

a method for obtaining data from a data stream to enable collection and/or amendment of said data prior to delivery of said data to a final output location;

the method comprising the steps of:

a) taking a system comprising;

a source of electronic data,

an input provided by the source of data and capable of transmission of said data to a first data processing station; and

an output in communication with said data processing station;

b) placing a software interface intermediate said input from said source of electronic data and said central processing station;

c) enabling the interface to interrupt data from said input before it reaches the first processing station; and

d) adjusting and/or compiling said data;

e) delivering said adjusted and/or compiled data at at least one system peripheral device.

Preferably, the at least one peripheral device is a printer which prints data which includes processed data from the data stream and said adjusted and/or compiled data

In another broad form of a method aspect the present invention comprises;

a method of adjusting data in a data stream transmitted between a source of data and a data printer, the method comprising the steps of;

a) providing a source of electronic data,

b) providing a printer in communication with said source of data and capable of performing at least one function responsive to said data stream;

c) providing an interface between said source of data and said printer for interrupting the data stream to enable the printer to thereby perform at least one additional print function.

In another broad form the present invention comprises;

a method for adjusting data printed by a POS printer such that the adjustment causes the printer to perform at least one function additional to its predetermined functions; the method comprising the steps of;

a) providing a source of electronic data emanating from at least one computer terminal,

b) providing at least one printer in communication with said computer terminal and which is capable of performing at least one function responsive to said data stream;

c) connecting an intelligent interface between said source of data and said at least one printer for interrupting the data stream to enable the printer to thereby perform at least one additional print function.

Further aspects and advantages of the present invention will become apparent from the ensuing description which is given by way of example only.

### DETAILED DESCRIPTION

The present invention will now be described according to preferred but non limiting embodiments and with reference to the accompanying illustrations wherein:

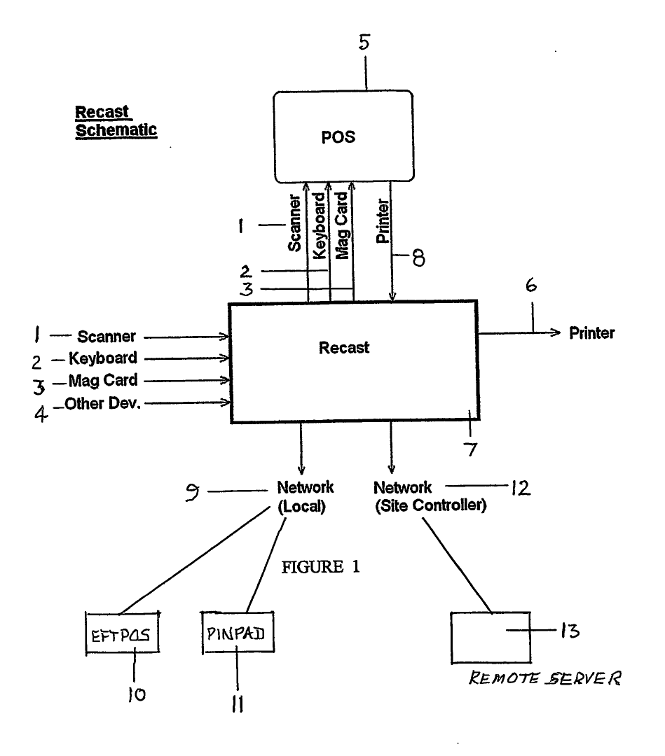

FIG. 1 is a schematic layout of a system according to a preferred embodiment of the invention.

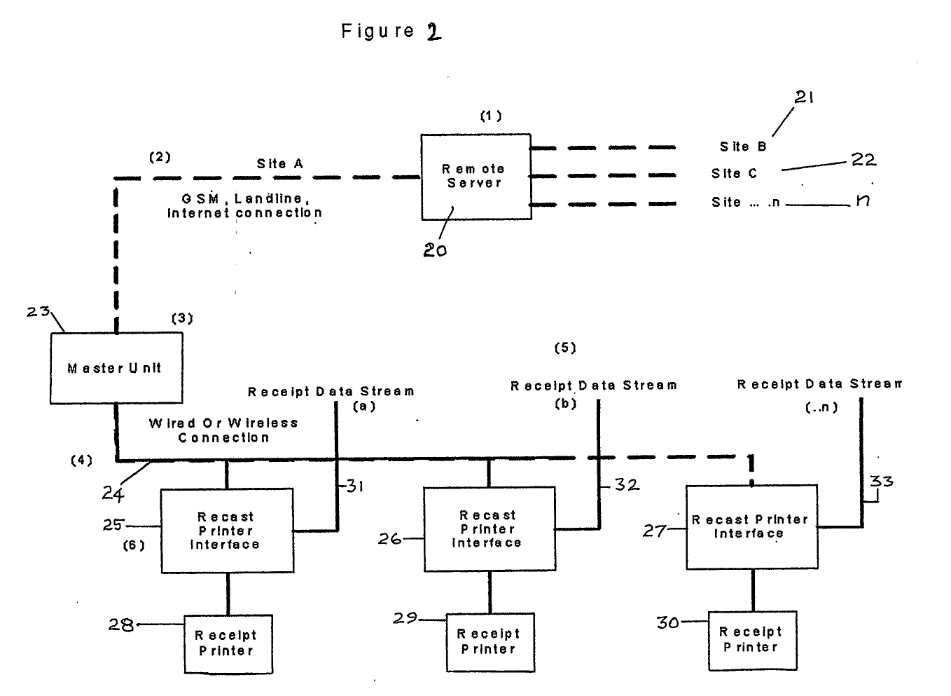

FIG. 2 shows a schematic layout of a point of sale system including an interface adapted to a plurality of printers.

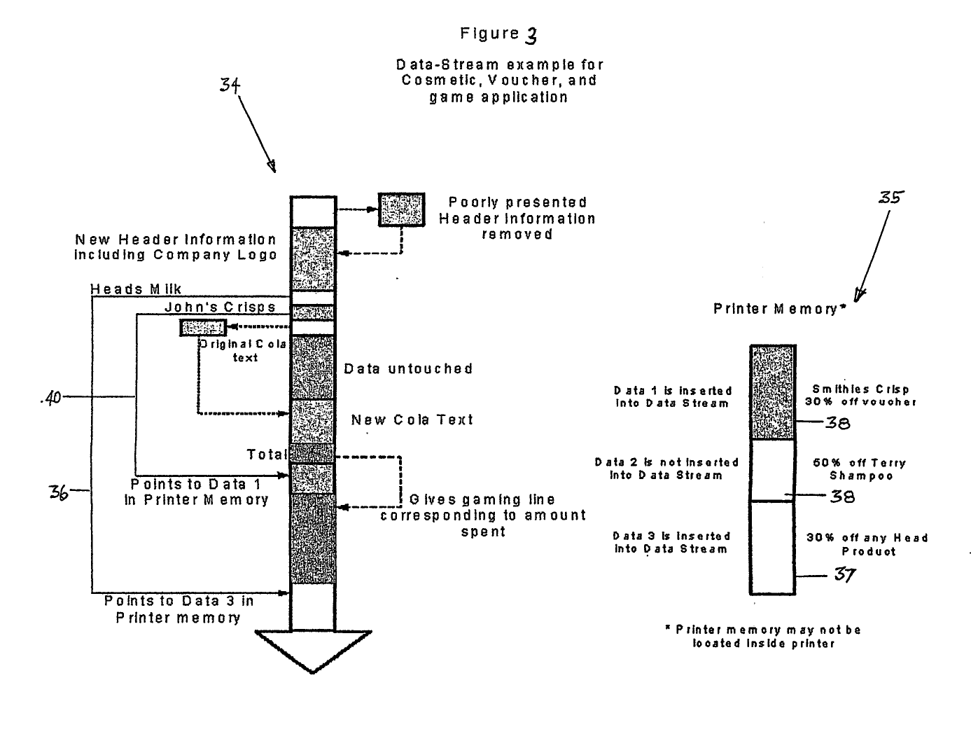

FIG. 3 shows an example application of the invention according to one embodiment.

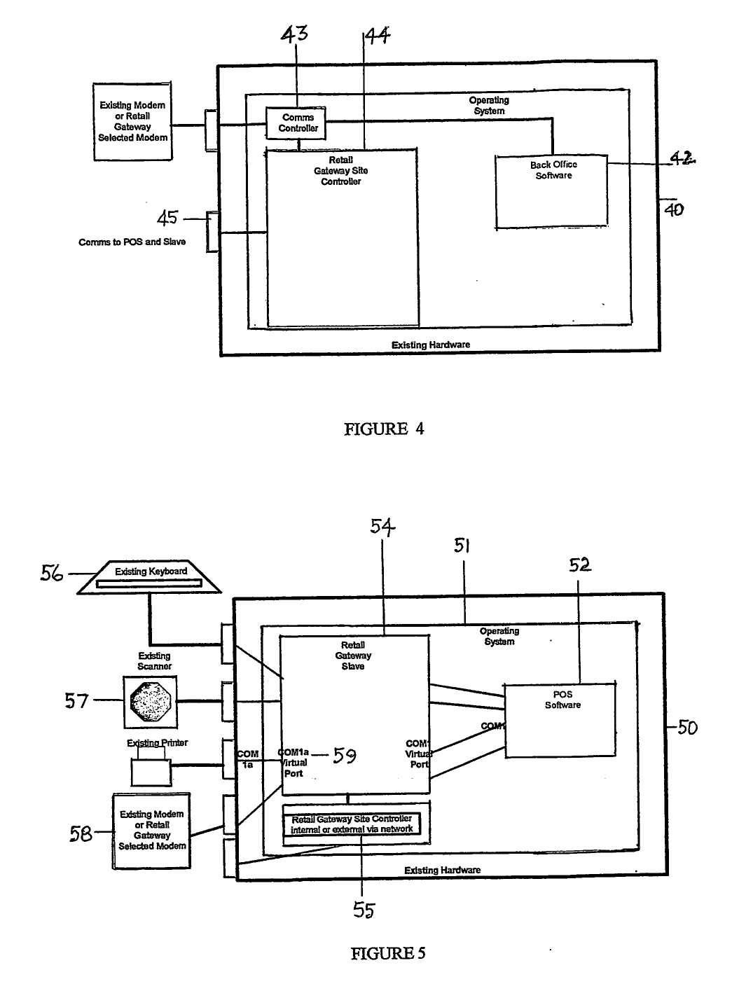

FIG. 4 shows a schematic layout of an alternative embodiment of the invention incorporating a site controller in existing hardware.

FIG. 5 shows a schematic layout of an alternative embodiment in which an interface is incorporated in software installed in a computer terminal at a point of sale.

The preferred embodiment of the invention will be described with reference to its use in a point of sale system for conducting customer transactions. It will be appreciated by persons skilled in the art that the invention is applicable in applications other than point of sale transactions.

Typically in a system according to a preferred embodiment of the invention a point of sale (POS) terminal (or cash register) functions as a source of data. A receipt printer associated with the POS terminal acts as a data consumer. This is a typical but not exclusive application of the invention as other data sources, such as POS journal outputs, and other data consumers, such as loyalty or statistical systems, may be connected instead. It is also possible that while many applications of the present invention provide an intelligent interface between a data source and data consumer, the system may also be configured such that an intelligent interface is connected in parallel with an existing printer, and promotional data is fed to a separate printer or device.

A typical existing system has a POS terminal communicating directly with a receipt printer. Through the addition of an interface connected between a POS terminal and receipt printer according to one embodiment, the receipt printer output may be enhanced to include many promotional instruments such as discount vouchers, advertising, lottery entries et al. Statistical data may additionally be collated and made available to an external system by means of a network connection of some kind. Where the data contained in the receipt needs to be parsed (such as when looking for the purchase of a specific product), there exists the requirement that the input data contains plain text (as opposed to some graphic representation of such text). However, in most POS implementations, data is able to be output to the printer in a simple text format, such as ASCII. As such, this information is easily readable and the content quickly determined.

According to one embodiment there is provided; an interface comprising s a separate physical device existing external to both data source and data consumer, with some provision for wired or wireless network connection. According to an alternative embodiment, there is provided an intelligent interface module that may be physically housed fully or partially within the data consumer itself with some provision for wired or wireless network connection. In a further embodiment, the data consumer device with the facilities of the invention is built in to its internal electronics, and with some provision for wired or wireless network connection. The present invention according to one of the preceding embodiments intercepting the incoming data stream, transmitting this data to an external processor through a network, receiving a manipulated data stream from a network, and outputting this data to the data consumer.

A wired or wireless network connection enables a site controller to manage each intelligent module such that data content may be altered or statistical data retrieved. A network connection in all cases is not essential, but typically a network will be used to gain the greatest benefit from the configuration of the interfaces which may then be administered remotely.

According to an alternative embodiment, a data source and data consumer connections are RS232 format, and the network connection is optionally RS485 format or wireless. According to a further embodiment connections are of the same form, but with parallel data source/consumer connections.

Although the invention is adaptable to a variety of applications, one preferred application is in conjunction with point of sale printers which are in communication with a point of sale computer. Such printers print out documents including receipts and other basic limited data concerning a transaction.

Many modem receipt printers feature an internal storage area into which graphic images may be loaded. This feature is used to provide the facility to print graphic images very quickly. Often this facility is ignored because; the programming of this data is technically difficult for untrained people. The POS systems either do not support or only support this feature for logo printing. The feature is time consuming to update, particularly where there are a large number of printers.

It is one advantage of the present invention that an interface or intelligent module or a plurality thereof is that they provide an easy and convenient way to update a large number of printers with internally stored graphic data.

A typical embodiment of a method aspect of the invention an interface or intelligent interface module is used to generate discount vouchers in a retail store environment using a network connection capability of the modules.

In this embodiment, the system administrator defines a set of graphics, and rules for their use. For example, a coupon to be printed by the printer may advertise a special offer on a product, printed when a competing product is purchased. Preferably, in this embodiment the following steps enable the implementation of the system.

1 A remote computer communicates with a site controller in a store at which the interface/intelligent module is installed. This communication may be effected using a modem or Internet.

2 Configuration data, including a graphic image and a triggering condition definition, is downloaded to the site controller by a server.

3 Statistical data held at the site controller is uploaded to the server for later analysis.

4 The server disconnects.

5 The site controller communicates with each interface/intelligent module, downloading the newly received data to each interface/intelligent module.

6 Each interface/intelligent module downloads the graphic image data directly to an internal storage memory of each printer.

The rules of when to print the image are held in the module and processed there as needed.

The following relates to a particular use of an interface between a computer and a receipt printer used in a retail operation. Reference to an interface win be taken to be a reference to an intelligent module. As can be appreciated the present invention has wider uses and applications outside this particular application.

Applications of the intelligent interface are varied, and may be grouped as functions that address connectivity and basic device control, and functions that address presentation of data. The groups of functions are however, complimentary.

Connectivity and Device Control Functions

A new printer may be desired to replace a legacy one for a number of reasons. The old printer may have failed or performed unsatisfactorily. Unfortunately, the legacy POS system may not be capable of operating the new printer due to compatibility issues, or features such as duplicate printing (common on impact dot matrix printers, but unusual on modem thermal printers) are absent.

The intelligent interface is capable of;

1. Emulating an old-style dot matrix interface, and translating command codes for the new printer.

2. Automatically generating multiple copies.

3. Buffering data to avoid possible data loss and change baud rates or handshaking of serial connections.

4. Monitoring printer status and act accordingly. For example raise an alert on low paper.

5. Operating a paper cutter automatically. If a legacy system has been designed around a tear-bar printer, then it probably has no direct way to signal the new printer to perform a paper cut.

6. Operating the cash drawer kick feature automatically. If a legacy system has been designed around an old printer, then it probably has no direct way to signal the new printer to perform a cash drawer kick.

Data Presentation Functions

The intelligent interface module can be used to enhance a printer output in a number of (non limiting) ways.

1. Addition of standard headers and footers on printed documents. Promotional features may be added to otherwise plain receipts such as a graphic company logo at the head of a receipt, and a greeting at the foot. Such additional material may be printed regardless of other information appearing on the receipt.

2. Addition of context sensitive material. Promotional features or other data may be added to receipts that depend on the information appearing on the receipt. For example, if a specific product is purchased, then a discount coupon may be automatically produced for a competing product Alternatively, if the value of the transaction exceeds a certain figure, then a voucher for a reward of some kind could be produced. There are many promotional schemes that could be tied to products, value, transaction time, or any other data produced in the receipt. It is also possible that standard terms and conditions relating to a product (e.g. rental terms) or type of sale (e.g. hire purchase terms) may be desired to be automatically printed.

3. Addition of controls of printer functions. For example, the font may be made larger, the printing may be made bold or underlined. These features are trivially available in most printer architectures, but are often not used.

The additional output may be directed to the connected printer, or to some other printer or device. The additional output may be data stored or generated by the intelligent interface, data stored in the printer memory, or data obtained in real-time through a network connection. The interface can also be used to remove unnecessary or blank lines if desired in an effort to conserve paper. As can be appreciated, the volume of dockets produced can be considerable and the removal of some lines, as long as they do not detract from the readability of the docket, can make considerable savings.

Promotional Features Facilitated by the Intelligent Interface

A potentially unlimited number of promotional features are readily implemented by the use of the intelligent interface. They include, but are not limited to, any combination of;

1. Production of receipts containing graphic logos and static promotional material

2. Production of receipts containing promotional material based on product(s) purchased.

3. Production of receipts containing promotional material based on time of purchase.

4. Production of receipts containing promotional material based on total value of transaction.

5. The use of a connecting network to obtain promotional or other material in real-time for inclusion in output data.

6. The use of a connecting network to return statistical information to a network server.

7. The use of a connecting network to provide a means to readily update the promotional material stored in the intelligent interface and any associated printer, and to update the rules regarding the generation of output data.

Example applications of the intelligent interface include;

1. Generation of discount vouchers.

2. Generation of discount vouchers with regard to product purchases.

3. Implementation of a lottery where a lottery ticket is generated in response to a transaction value exceeding a threshold. Ticket details for which are sourced through a network connection or stored in an internal cache or generated internally.

4. Implementation of a prize-draw promotion where a stub ticket is printed. The winner to be drawn from a pool of entries.

5. Providing compatibility between modem hardware and legacy systems.

It can be seen that the present invention provides a number of advantages over the prior art Some of these advantages include:

Improved readability of dockets and receipts,

Increased brand identification with graphic logos.

Ability to read the data stream and extract any pre-defined instruction.

Ability to insert Vouchers into the data-stream by activation of predetermined triggers in the data-stream

Ability to insert Gambling or gaming features by activation of predetermined triggers in the data-stream.

Ability to insert vouchers and gambling/gaming features independent of the need for any input data-stream.

Ability to download new control and display data.

Is configurable to read from any source of the data-stream.

Allows for a simple upgrade of an existing system independent of computer type (e.g. UNIX, IBM, Macintosh).

Is configurable to support all printers with no changes to existing software systems software,

Easy to configure for specific printers.

May correct erroneous information, such as a changed address, without changing system software,

May be configured at whim, so frequent changes are no problem and inexpensive.

May save time and paper, depending on set up.

Enable rapid deployment of new promotional material and infrastructure.

It should be appreciated that the format of the data being sent to the printer may be changed considerably according to prescription. For example, the interface may receive ASCII format text, but for enhancement to the printer, may print a bar code. This could be used in situations where it is desired to label products, or provide a ticket which can be scanned for other uses e.g. car washes, lotteries, vouchers.

FIG. 1 shows a schematic layout of a system according to a preferred embodiment of the invention.

The embodiment of FIG. 1 may be used in a retail (point of sale—POS) application to convert the output of a retail computer in such a way to produce-an enhanced output of a printer which would normally be connected directly to that retail computer.

According to FIG. 1 in a typical arrangement there is provided a source of data from devices such as a scanner 1, keyboard 2, magnetic card 3 or other device 4. Other Device 4 refers to other devices that may be integrated through the existing ports. This includes PS2 as well as other serial and/or parallel devices. These devices may be integrated without change to, or knowledge of, the connected POS system (unless they are normally connected to the POS directly). For example, it may be desirable to connect a 2D barcode scanner to a simple POS that has no ability to connect to such devices. In that case the interface 7 connects to the 2D scanner 1 and presents data to the POS through an interface or interfaces the POS is designed to accept.

Data from any one (or all) of the devices 14 is delivered to point of sale computer terminal 5 for processing before transmission in the usual manner to a printer 6. Data from devices 14 may be transmitted via interface 7 which is placed intermediate devices 1-4 and computer terminal 7. In this embodiment, a data stream 8 is output from the retail computer 5 in preferably ASCII format and is received by the interface 7.

Interface 7 then outputs control codes to the printer 6 which cause the printer to print an enhanced output containing a data stream manipulated by the interface 7 and if used, additional text and graphics on a print out.

It should be appreciated that by providing an interface 7 that can plug in between the computer 5 and the printer 6, changes to the printer output can be readily achieved without changing the system software of the retail computer 5. 1. Also it should be appreciated that there may be multiple printers (or other output devices) connected to the one interface or multiple interfaces.

Data received from connected devices 1-4 may be passed directly to the POS computer 5 or may be manipulated, validated or substituted as necessary. According to one embodiment, an input from one interface may cause an output to several—or no—devices.

In communication with interface 7 is a local network 9 which represents a network of devices connected locally to the interface 7 at the POS. Examples of such devices could be Eftpos 10 or pinpads terminals 11 through which data may be manually entered or services rendered or requested.

In one embodiment, there is provided a Network (Site Controller 12) providing a connection between all POS terminals and the site controller 12. This network may be used for uploading of statistical data to the POS via interface 7, downloading configuration data from POS computer 5, and other communications tasks such as validation of a coupon or voucher.

Interface 7 shown schematically in FIG. 1 may be implemented. as a piece of hardware external to the existing POS computer 5 or as a software module within the POS computer 5 (working at a driver level to intercept and redirect data), or a mixture of the two.

Potential applications of the system according to alternative embodiments include:

1 using existing magnetic cards (any one chosen such as visa to club card) to act as a loyalty card.

2 reading a bar code at a checkout to check if a lottery ticket is a winning one. The idea to do this is set out below.

3 reading bar codes and redirecting the relevant data stream to the interface unit

4 The use of the existing pos scanner to identify and redirect any relevant information away from the POS system and into the Recast unit to read a bar code directly.

For example, in a case where a Lottery ticket needs to be checked to see if it is a winning ticket, the existing POS scanner reads the bar code. From the first few digits it can be identified if this products/information needs to be sent to the interface unit, left in its current state and sent to the POS system or both. For the lottery example, the need to check if this is a winning ticket can be done at the checkout by reading the barcode on the lottery and then an “interface redirect module” (a separate piece of hardware inserted between the existing scanner 1 and POS 5 input) removes this information from a data output stream of the scanner and redirects the data to the interface 7. This data is then processed by sending the information via the site controller 12 to a remote lottery server 13 which checks if the ticket is a winning ticket. The result of the ticket (win/loss) is then sent and is printed on the receipt printer 6 or other output device.

FIG. 2 shows a schematic layout of a point of sale system including an interface adapted to a plurality of printers.

The system shown includes a remote server 20 which is in communication with a potentially unlimited number of sites 21, 22 and n. Server 20 is connected via a landline, GSM or Internet connection to a master unit 23 which communicates via a wired or wireless connection 24 with respective interfaces 25, 26 and 27. Interfaces 25, 26 and 27 are respectively connected with output printers 28, 29 and 30. Interfaces 25, 26 and 27 receive a data stream via respective connections 31, 32 and 33 from devices (not shown) which may be a scanner, bar code reader, keyboard or other device as described with reference to FIG. 1.

FIG. 3 shows an example of an application of the invention according to one embodiment. In the example shown, a system of operating loops in a primary system 34 enable a consequential output at a printer which includes a printer memory 35 triggered by an event in primary system 34. An event may be loop 36 which points to location of data in data set 37 in printer memory 35. Printer memory 35 may be segmented into data sets such as 37 and 39 which correspond to loops 36, and 40. If a consumer purchases Heads Milk then data set 37 in printer memory 35 is triggered providing a consumer with a 30% discount on Head products. Likewise, loop 40 may trigger data set 38. These are merely examples of potentially thousands of ways printer outputs or outputs from other output devices may be manipulated based on one or more predetermined trigger event/s.

FIG. 4 shows a schematic layout of an alternative embodiment, in which a software interface is incorporated in a computer terminal at a point of sale.

As described previously the interface intercepts data to existing Point of Sale peripherals to interrogate and control barcodes and keystroke inputs to the POS whereupon additional or manipulated information is printed on a receipt docket. This information in turn can be reported back to a separate Site controller unit (item 12 FIG. 1) and then transmitted via the internet to a remote server 13 (see FIG. 2) location.

The existing system physically intercepts cable connections to the POS computer 5 (see FIG. 1) and feeds them through an interface. Each interface unit in turn is connected by a RS485 network to the site controller 12. This enables minimal interference with the current POS computer 5 or like processing unit. This is a simple and unique approach which allows the interface System to be easily retry fitted to existing POS systems.

The hardware interface embodiment may be expensive in single POS systems. Larger systems can absorb such costs due to the major benefits provided by the interface system.

Many existing POS systems run off a windows platform and the hardware is PC compatible.

A site controller will take less than one week to be ported to a pc platform. This enables sites which currently have a permanent input connection and a spare communications port for the RS485 network to significantly save the hardware cost of the Site Controller. If the communications were not present then a simple GPRS modem could be connected more cheaply that the site controller.

Referring to FIG. 4 there is shown a schematic layout of an alternative embodiment of the invention incorporating a site controller in existing hardware. Existing POS hardware 40 incorporates therein an operating system 41 including (back office) software 42. The operating system further comprises a communications controller 43 and a site controller 44. Site controller 44 communicates via communications port 45 with a point of sale terminal (not shown).

FIG. 5 shows a schematic layout of an alternative embodiment, in which an interface is incorporated in software installed in a computer terminal at a point of sale.

In an alternative embodiment, there is provided a software version of the interface or gateway for both the master and slave.

The slave has been written to be an embedded MCU solution, to port to a pc platform shared by POS software. Initially there is a port to a C++ platform and then a re-write in a C++ environment ensuring that no interference with existing POS software occurs. According to one embodiment, the method would involve intercepting the same data as with the hardware version but instead of being on the outside of the POS the interception is done internally. FIG. 5 shows a schematic arrangement of a software slave interface. This alternative embodiment of the invention incorporates a site controller 50 in existing hardware 51. Existing POS hardware 50 incorporates therein an operating system 51 including POS software 52. The operating system further comprises a communications port 53 which is in communication with POS software 52 and, a gateway interface 54. Gateway interface 54 is in communication with site controller 55 which may be internal or external via an external network (not shown). Gateway controller 54 may be incorporated internally within existing hardware or remotely via a network. The arrangement shown in FIG. 5 includes input devices such as a keyboard 56, scanner 57 or modem 58. Gateway controller 54 communicates via communications port 59 with a point of sale terminal (not shown).

According to one embodiment, the Slave software would have to emulate a port so the POS software would think it is taking to the hardware communications ports. So COM 1 would be renamed COM1a which the slave software would talk too. A Slave input virtual port would be named COM1 so as far as the POS software was concerned it would be talking to COM1. Programs are available which allow this manipulation.

Advantages

The platform may be offered as standard API's to current POS software manufacturers, while a supplier maintains control of the promotions engine. The POS manufacturers would be allowed to tailer any of the peripheral support to best integrate with their software. This would increase the flexibility of the product.

Aspects of the present invention have been described by way of example only and it should be appreciated that modifications and additions may be made thereto without departing from the scope thereof.

1. A system for collecting and/or adjusting and/or manipulating data from a data stream: the system comprising;
a source of electronic data,
an input provided by the source of data and capable of transmission of said data to a first data processing station;
an output in communication with said data processing station;
an intelligent interface intermediate said input from said source of electronic data and said central processing station; wherein, the interface is capable of interrupting data transmitted between said input and the first processing station to adjust and/or compile at least a part of said data.

2. A system according to claim 1 wherein, the adjusted data is transmitted to a peripheral device in communication with the first processing station.

3. A system according to claim 1 wherein the data adjusted by the interface is transmitted to a secondary processing station

4. A system according to claim 2 wherein the first processing station is a point of sale terminal.

5. A system according to claim 4 wherein the secondary data processing station is preferably a site controller capable of communication with at least one adjusted and/or compiled and/or manipulated data stream.

6. A system according to claim 5 wherein, the secondary data processing station may be located either at the point of sale or at a remote location.

7. A system according to claim 6 wherein, the secondary processing station is capable of uploading of statistical data and down loading configuration data to a point of sale peripheral device.

8. A system according to claim 7 wherein, the secondary data processing station may perform tasks such as validation of a customer coupon or voucher.

9. A system according to claim 8 wherein, said output from said first processing station communicates with a POS printer.

10. A system according to claim 9 wherein the source of data comprises a scanner.

11. A system according to claim 9 wherein the source of data comprises a weigher.

12. A system according to claim 9 wherein the source of data comprises a magnetic card.

13. A system according to claim 12 wherein the source of data comprises an EFTPOS scanner.

14. A system according to claim 13 wherein, the source of data comprises a key board.

15. A system according to claim 14 wherein the peripheral device in communication with the first processing station is a point of sale printer.

16. A system according to claim 14 wherein the output comprises a customer display.

17. A system according to claim 14 wherein the output device comprises a lottery terminal

18. A system according to claim 14 wherein the output device comprises an EFTPOS.

19. A system according to claim 1 wherein output data may include content that is pre-loaded into the interface,

20. A system according to claim 9 wherein, the source of electronic data providing said input may be one of or any combination of following devices:
a) a scanner
b) keyboard
c) a magnetic card.

21. A system according to claim 1 wherein, the interface enables data transmitted between said input and the first processing station to be intercepted for secondary adjustment, compilation, manipulation, variation or the like.

22. A system according to claim 1 wherein, the interface is in communication with a remote server and the remote server is in communication with a controller which links one or more remote sites to the remote server.

23. A system for interrupting data in a data stream: the system comprising a source of electronic data,
an input provided by the source of data and capable of transmission of said data to a first data processing station;
an output in communication with and from said data processing station;
an interface intermediate said input from said source of electronic data and said central processing station; wherein, the interface is capable of interrupting data from said input before it reaches the processing station; whereupon said data is processed at a secondary processing station wherein the data is used for adjusting and/or compiling said data for use at the first processing station.

24. A system for adjusting data in a point of sale data stream: the system comprising;
a source of electronic data,
a printer capable of performing at least one function responsive to said data stream;
an interface for interrupting and adjusting the data stream to enable the printer to thereby perform at least one additional print function.

25. A system for controlling the printing of data at a point of sale (POS) terminal, the system comprising:
a source of data producing a data stream;
a printer responsive to a POS computer and which performs at least one print function responsive to the data stream; the system further comprising at least an interface which is capable of adjusting and/or manipulating and/or compiling said data in said data stream thereby allowing the printer to print data from the data stream and/or said manipulated and/or adjusted data.

26. A system according to claim 25 wherein, the interface is in communication with a remote server and the remote server is in communication with a controller which links one or more remote sites to the remote server.

27. A system according to claim 26, wherein the interface is capable of adjusting said data in said data stream thereby allowing the printer to print data additional to or adjusted from data in the data stream.

28. A system according to claim 27 wherein the additional print data is based on POS information obtained by said interface directly or indirectly from the POS computer.

29. A system according to claim 28 wherein the POS computer terminal is a cash register which delivers a data stream to a receipt printer.

30. A system according to claim 29 wherein the data is manipulated, altered, augmented, amplified or otherwise adjusted via an interface which is either local to or remote from the printer.

31. A system according to claim 1, wherein, the interface connection is wireless. According to an alternative embodiment, the interface connection is wired.

32. A system according to claim 31 wherein, there are a plurality of printers at a point of sale site and a controller at either the POS site or at a remote location thereby enabling control of multiple printers.

33. A system according to claim 1 wherein the interface comprises software embedded in a point of sale computer.

34. An electronic interface for insertion between a source of electronic data and a printer which performs at least one print function responsive to said data: wherein the interface includes means to interrupt and adjust said data stream so that the printer prints either data from said source and/or data generated by the interface.

35. A method for obtaining data from a data stream to enable collection and/or amendment of said data prior to delivery of said data to a final location;
the method comprising the steps of:
a) taking a system comprising;
a source of electronic data,
an input provided by the source of data and capable of transmission of said data to a first data processing station; and
an output in communication with said data processing station;
b) placing an interface intermediate said input from said source of electronic data and said central processing station;
c) enabling the interface to interrupt data from said input before it reaches the first processing station; and
d) adjusting and/or compiling said data;
e) presenting said adjusted and/or compiled data at at least one system peripheral device.

36. A method according to claim 35 wherein the at least one system peripheral device is a remote printer.

37. A method according to claim 36 comprising the further step of providing an interface modem connected between the data input and the first processing station.

38. A method according to claim 37, comprising the further step of providing a software interface associated with the first processing station.

39. A method according to claim 38 wherein the software communicates with the data stream and intercepts and/or compiles and/or adjusts and/or manipulates the data for either storage or for subsequent delivery to an output such as a point of sale (POS) printer.

40. A method for obtaining data from a data stream to enable collection and/or amendment of said data prior to delivery of said data to a final output location;
the method comprising the steps of:
a) taking a system comprising;
a source of electronic data,
an input provided by the source of data and capable of transmission of said data to a first data processing station; and
an output in communication with said data processing station;
b) placing a software interface intermediate said input from said source of electronic data and said central processing station;
c) enabling the interface to interrupt data from said input before it reaches the first processing station; and
d) adjusting and/or compiling said data;
e) delivering said adjusted and/or compiled data at at least one system peripheral device.

41. A method according to claim 40 wherein, the at least one peripheral device is a printer which prints data which includes processed data from the data stream and said adjusted, compiled or manipulated data.

42. A method of adjusting data in a data stream transmitted between a source of data and a data printer, the method comprising the steps of;
a) providing a source of electronic data,
b) providing a printer in communication with said source of data and capable of performing at least one function responsive to said data stream;
c) providing an interface between said source of data and said printer for interrupting the data stream to enable the printer to thereby perform at least one additional print function.

43. A method for adjusting data printed by a POS printer such that the adjustment causes the printer to perform at least one function additional to its predetermined functions; the method comprising the steps of;
a) providing a source of electronic data emanating from at least one computer terminal,
b) providing at least one printer in communication with said computer terminal and which is capable of performing at least one function responsive to said data stream;
c) connecting an intelligent interface between said source of data and said at least one printer for interrupting the data stream to enable the printer to thereby print data from the interface and/or from the source of data.

44. A method according to claim 43 wherein data is communicated between a central server to a site controller, which then disseminates the data via a wireless or wired network, or both, to the intelligent interface.

45. A method according to claim 44 wherein the output data may contain content that is pre-loaded into the interface

46. A system according to claim 19 potentially unlimited number of promotional features are readily implemented by the use of the intelligent interface.

47. A system according to claim 19 wherein the remote output device may perform the following function; auction of receipts containing graphic logos and static promotional material.

48. A system according to claim 19 wherein the remote output device may perform the following function; production of receipts containing promotional material based on product(s) purchased.

49. A system according to claim 19 wherein the remote output device may perform the following function; production of receipts containing promotional material based on time of purchase.

50. A system according to claim 19 wherein the remote output device may perform the following function; auction of receipts containing graphic logos and static promotional material

51. A system according to claim 19 wherein the remote output device may perform the following function; production of receipts containing promotional material based on total value of transaction.

52. A system according to claim 19 wherein the remote output device may perform the following function; auction of receipts containing graphic logos and static promotional material

53. A system according to claim 19 wherein the remote output device may perform the following function; the use of a connecting network to obtain promotional or other material in real-time for inclusion in output data.

54. A system according to claim 19 wherein the remote output device may perform the following function; the use of a connecting network to provide a means to readily update promotional material stored in the intelligent interface and any associated printer, and to update the rules regarding the generation of output data.

55. A system according to claim 1 wherein the intelligent interface is capable of performing any one of the following functions:
a) Generation of discount vouchers.
b) Generation of discount vouchers with regard to product purchases.
c) Implementation of a lottery where a lottery ticket is generated in response to a transaction value exceeding a threshold.
c) Implementation of a prize-draw promotion where a stub ticket is printed and a winner is drawn from a pool of entries.

56. A system according to claim 1 wherein the intelligent interface is capable of performing a potentially unlimited number of promotional features using an intelligent interface.

57. A system according to claim 1 wherein the intelligent interface is capable of enabling any one of or any combination of the following functions:
a) production of receipts containing graphic logos and static promotional material,
b) production of receipts containing promotional material based on product(s) purchased
c) production of receipts containing promotional material based on time of purchase
d) production of receipts containing promotional material based on total value of transaction
e) the use of a connecting network to obtain promotional or other material in real-time for inclusion in output data.
f) the use of a connecting network to return statistical information to a network server.
g) the use of a connecting network to provide a means to readily update the promotional material stored in the intelligent interface and any associated printer, and
h) to update the rules regarding the generation of output data.

58. A system according to claim 1 wherein the intelligent may be implemented. as a piece of hardware external to an existing point of sale computer or as a software module within said point of sale computer (working at a driver level to intercept and redirect data), or a mixture of the two.

59. A system according to claim 1 wherein, the output data contains content that is pre-loaded into the interface,
